(19) United States
(12) Patent Application Publication
(10) Pub. No.: US 2012/0260616 A1
(43) Pub. Date: Oct. 18, 2012

(54) EXCHANGEABLE FILTER MODULE FOR A HOUSING

(75) Inventors: Klaus Leister, Weinheim (DE); Hannes Clasen, Heidelberg (DE); Thomas Fischer, Darmstadt (DE)

(73) Assignee: CARL FREUDENBERG KG, Weinheim (DE)

(21) Appl. No.: 13/449,367

(22) Filed: Apr. 18, 2012

(30) Foreign Application Priority Data
Apr. 18, 2011 (DE) 10 2011 017 444.3

(51) Int. Cl. B01D 46/42; B01D 46/52; B01D 46/10

(52) U.S. Cl. 55/385.7; 55/502; 55/488

(57) ABSTRACT

A replaceable filter module is configured to be flanged to a wall of a housing that holds a fuel cell. The filter module includes a filter element with a filter medium and at least one of a seal and sealing elements. The seal includes one of a key-and-lock connection, a plug-and-socket connection, and a tongue-and-groove connection.

### CROSS REFERENCE TO RELATED APPLICATIONS

This application claims priority to German Patent Application No. DE 10 2011 017 444.3-45, filed Apr. 18, 2011, which is hereby incorporated by reference herein in its entirety.

### FIELD

The invention relates to a replaceable filter module.

### BACKGROUND

Fuel cells require filtered intake air during operation. For this purpose, a filter element is normally installed in the intake air stream of a fuel cell. After a certain period of operation of the fuel cell, however, the filter element employed is spent and can no longer be used.

When the filter element is being replaced or changed, or being installed into or removed from a housing that holds a fuel cell, numerous parameters and safety precautions have to be observed in order to ensure problem-free operation of the fuel cell over the long run.

Here, it is especially disadvantageous that, in order to replace the filter element, there is often a need to access the inside of the housing, a process in which contamination cannot be ruled out.

It is likewise disadvantageous that a tool is needed to change the filter element.

When the intake air for a fuel cell is being filtered, it must be ensured that there are no leakages or bypasses through which unfiltered air can reach the fuel cell. The precautions that have to be taken for this purpose often entail high costs and call for complicated sealing designs.

Therefore, there is a need for a structural solution by means of which the exhausted filter elements can be replaced without any problem.

### SUMMARY

In an embodiment the present invention provides a filter system for the intake air of a fuel cell that can be replaced without any problem and that allows lasting and reliable operation of a fuel cell.

In an embodiment, the present invention provides a replaceable filter module to be flanged to a wall of a housing that holds a fuel cell. The filter module includes a filter element with a filter medium and at least one of a seal and sealing elements. The seal includes one of a key-and-lock connection, a plug-and-socket connection, and a tongue-and-groove connection

### BRIEF DESCRIPTION OF THE DRAWINGS

Exemplary embodiments of the present invention are described in more detail below with reference to the drawings, in which:

FIG. 1 shows a replaceable filter module with a pleated filter medium and an optionally profiled foam seal,

FIG. 2 shows a replaceable filter module with a first sensor,

FIG. 3 shows a replaceable filter module with a pleated filter medium on which a flat filter medium has been placed on the unfiltered air side,

FIG. 4 shows a replaceable filter module with a pleated filter medium on which several flat filter media have been placed on the unfiltered air side, whereby a covering grid adjoins it on the on the unfiltered air side,

FIG. 5 shows a replaceable filter module with a flow guide that has an inlet piece on whose outer circumference sealing rings are arranged,

FIG. 6a shows a part of the wall of the housing that holds a fuel cell, whereby an inlet piece can be inserted into the part, whereby a closure cap is provided on the housing,

FIG. 6b shows a part of the wall of the housing that holds a fuel cell, whereby an inlet piece is inserted into the part, whereby a closure cap is provided on the housing,

FIG. 7a shows a part of the wall of the housing that holds a fuel cell, whereby an inlet piece can be inserted into the part, whereby a sensor is provided on the housing,

FIG. 7b shows a part of the wall of the housing that holds a fuel cell, whereby an inlet piece is inserted into the part, whereby a sensor is provided on the housing as well as on the inlet piece,

FIG. 8a shows a profiled part of the wall of the housing that holds a fuel cell, whereby an inlet piece with a profile in the form of a plug-and-socket connection type can be inserted into the part,

FIG. 8b shows a profiled part of the wall of the housing that holds a fuel cell, whereby an inlet piece with a profile of the plug-and-socket connection type is inserted into the part, and

FIG. 9 shows a housing with a replaceable filter module with a pleated filter medium on which several flat filter media have been placed on the unfiltered air side, whereby a covering grid adjoins it on the on the clean air side, and whereby the replaceable filter module has a flow guide with a profiled inlet piece.

### DETAILED DESCRIPTION

It has been recognized that a replaceable filter module, as in embodiments of the invention, can be replaced quickly and is easily accessible from the outside. According to embodiments of the invention, the replaceable filter module can be secured to an easily accessible wall of the housing and can then be removed from there, thereby freeing an intake air opening. Here, it has been concretely recognized that the replaceable filter module creates a mechanically sturdy and fluid-tight seat against the wall, thereby sealing the housing. It has been also concretely recognized that this attains absolute tightness of the intake air line while air flows uniformly over the filter element, and also that this achieves a cost reduction during the operation of the fuel cells. Furthermore, it has been recognized that, thanks to the replaceable filter module according to embodiments of the invention, the fuel cells are easier to maintain and can consequently be operated problem-free for a long period of time.

The replaceable filter module has a seal and/or sealing elements. The seal and/or the sealing elements can be arranged either directly on the filter element or else on a filter housing that holds the filter element. The seal and/or the sealing elements permit a tight seat of the replaceable filter module without the occurrence of leakages and bypass flows from the unfiltered air side to the clean air side.

The seal could be in the form of a key-and-lock connection, a plug-and-socket connection or a tongue-and-groove connection. In this context, it is concretely conceivable for the seal to have a projection that engages into an indentation in a flow guide or in the wall of the housing so as to create a seal. The above-mentioned connections ensure that the replaceable filter module is centered.

The replaceable filter module could have a first sensor. The first sensor can be arranged directly on the filter element or else on a filter housing. By changing color or by emitting an electric signal, the first sensor can indicate whether the filter element has to be replaced. It is preferably configured as a noxious gas dosimeter.

The filter element could have a pleated filter medium and/or at least one flat filter medium. Both filter media serve for particle filtration and for the chemical filtration of gases that are harmful to the fuel cells. Both filter media can contain adsorbers and/or absorbers. Before this backdrop, it is concretely conceivable for the flat filter medium to be configured in such a way that it adsorbs or absorbs gases that are harmful to fuel cells. The flat filter media can be configured as foams, sintered media, packings, media with a honeycomb structure or with a grid structure. Flat filter media make use of the installation space efficiently, thus making it possible to arrange a large number of adsorbers and/or absorbers in this installation space. The pleated filter medium advantageously brings about a slight pressure loss and is preferably made of a nonwoven, of adsorbers and/or of absorbers. The pleated filter medium could be pleated lengthwise or crosswise to the flow direction of the intake air into the fuel cell. The filter element can filter hydrocarbons and/or particles. The pleated filter element then only brings about a slight pressure loss when it is pleated lengthwise to the flow direction. When it is pleated crosswise to the flow direction of the intake air, the folds lie upon the other, giving rise to a pleated filter medium having the properties of flat filter media stacked upon each other. This is associated with a relatively high pressure loss and a high capacity.

The filter element could be held in a filter housing. In this manner, the filter element is protected from being deformed.

The filter element could be connected to a flow guide in a leak-proof manner, whereby the connection can be made positively or non-positively, especially through the use of gluing, casting and/or welding techniques. The flow guide conveys the intake air to the fuel cell in such a way that the filter element is uniformly loaded or exhausted. Preferably, the flow guide is configured to be funnel-shaped or to have a trapezoidal cross section. The flow of gas that is harmful to fuel cells should be as uniform as possible as it passes through the filter elements or the adsorbers or absorbers used for filtering the intake air of a fuel cell, thus exhausting these filter elements.

The flow through the particle filters equalizes of its own accord in that more particles are deposited in the areas with a stronger flow than are deposited in the areas with a weaker flow. The pressure loss in the areas with the strong flow increases due to the particle deposits. The intake air then flows more strongly through the areas that had previously had the weak flow. This “automatic” equalization of the flow does not work with chemical filters.

For this reason, it is particularly desirable to exhaust the chemical filtering capacity of a filter element uniformly. This is why a filter guide is created that ensures that the filter element is uniformly exhausted over its entire inflow surface. Elements, especially grids or perforated plates, can be positioned inside the flow guide or the filter housing in order to equalize the flow of the intake air.

Before this backdrop, the flow guide could have a connection piece that can be inserted into the wall. In this manner, the replaceable filter module can be modularly inserted into a receptacle in the wall of the housing without any problem.

According to embodiments of the invention, a replaceable filter module is proposed to be flanged onto a wall of a housing that holds a fuel cell, said module comprising a filter element with a filter medium and an inlet piece that is to be inserted into the wall, whereby the inlet piece is configured in such a way that it interacts like a key-and-lock connection or a plug-and-socket connection with a receptacle that can be arranged in the housing.

As explained above, the inlet piece and the receptacle in the wall could be configured like a key-and-lock connection or a plug-and-socket connection. Thus, the inlet piece could be profiled and the receptacle could have profiling that is complementary to the profiling of the inlet piece. As a result, the inlet piece can be non-rotatably inserted into a receptacle that has profiling that is configured to be complementary to the profiling of the inlet piece. Therefore, the replaceable filter module is always mounted correctly onto such a housing that interacts with the replaceable filter module so as to operate properly.

The flow guide could taper in the direction of the inlet piece. In this manner, the flow guide can be removed from an injection mold without any problem. Slides or other auxiliaries can be dispensed with.

The flow guide could have a second sensor. The second sensor can be used to determine the noxious gas concentration in the clean air. The second sensor can also be configured as a mass flow sensor, a volume flow meter, a pressure sensor, or a particle-detecting sensor.

A housing with a wall that holds a fuel cell in its interior, whereby the interior of the housing is shielded by the wall, could have a replaceable filter module of the type described here, whereby the replaceable filter module is accessible from the outside and can be detached from the wall. In this manner, an exhausted filter element can be replaced from the outside without any problem, without having to access the interior of the housing in which the fuel cell is held.

The replaceable filter module could be connected to the wall by a fixation means. The fixation means could especially be screws, adhesive elements or clip elements.

The fixation means could especially be configured as a tenter frame that presses the replaceable filter module into an opening in the wall. This allows a quick assembly.

A third sensor could be provided on the housing. In this manner, it can be detected whether a replaceable filter module has been installed. In particular, it can be detected whether the right replaceable filter module has been installed.

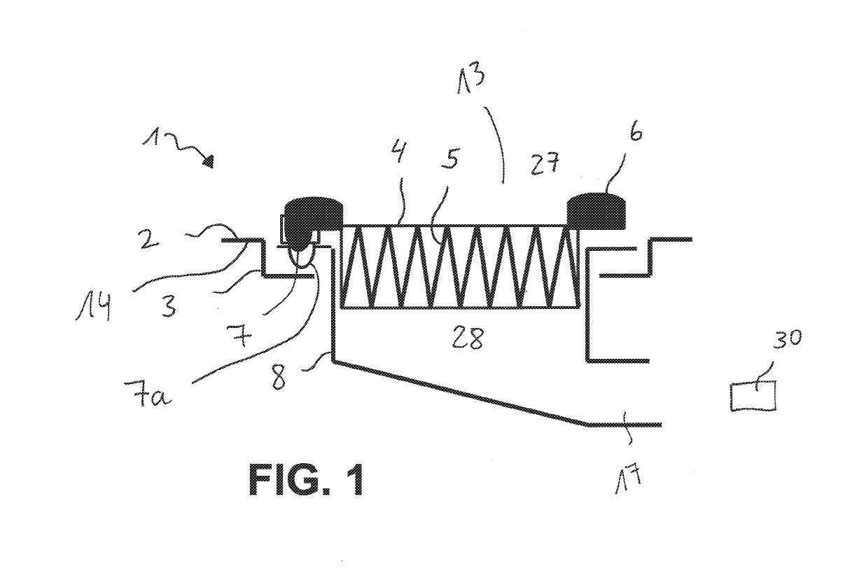

FIG. 1 shows a replaceable filter module 1 to be flanged onto a wall 2 of a housing 3 that holds a fuel cell 30, said module comprising a filter element 4 with a filter medium 5. The filter element 4 comprises a pleated filter medium 5. A seal 6, namely, a foam seal, is arranged on the filter element 4. The seal 6 is configured in the form of a key-and-lock connection, namely, it is profiled. A projection 7 protrudes from the seal 6 and it engages into an indentation 7a in a flow guide 8. The filter element 4 is connected to the flow guide 8 so as to be leak-proof. The flow guide 8 widens in the direction of the inlet piece 17.

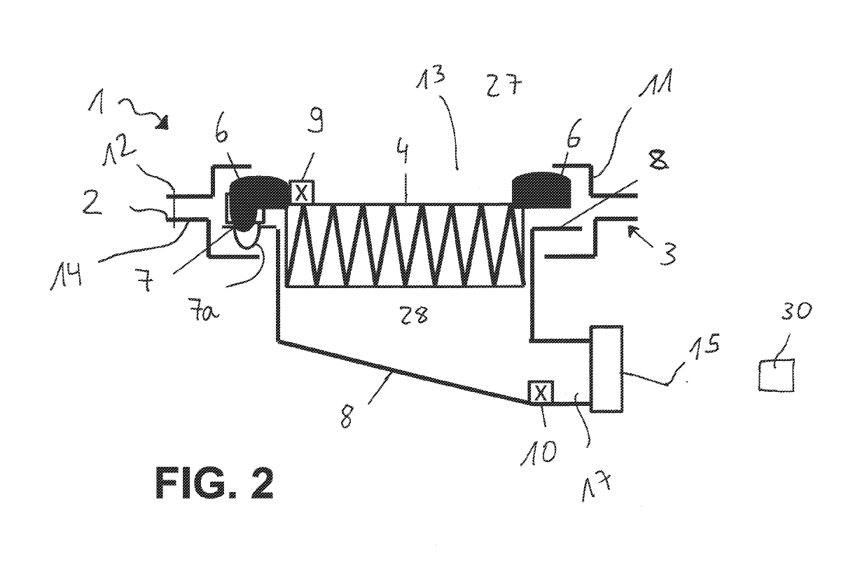

FIG. 2 shows a replaceable filter module 1 with a structure that is similar to the one shown in FIG. 1, whereby a first sensor 9 is associated with the filter element 4. The first sensor 9 is configured as a noxious gas dosimeter. By changing color or by emitting an electric signal, the first sensor indicates whether the filter element 4 is exhausted and has to be replaced.

In the embodiment shown in FIG. 2, the flow guide 8 has a second sensor 10. The second sensor 10 can be used to determine the noxious gas concentration in the clean air. The second sensor 10 can also be configured as a mass flow sensor, a volume flow meter, a pressure sensor, or a particle-detecting sensor.

FIG. 2 concretely shows a housing 3 that holds a fuel cell 30 and that has a wall 2 as well as a replaceable filter module 1, whereby the replaceable filter module 1 is accessible from the outside and can be detached from the wall 2, and whereby the replaceable filter module 1 is connected to the wall by a fixation means 11. The fixation means 11 is configured as a tenter frame. The tenter frame is secured to the wall 2 by means of a rapid-action closure 12. For this purpose, the wall 2 has a flange 14. The tenter frame presses the replaceable filter module 1 into the flow guide 8 that is inserted into an opening 13 in the wall 2.

At the end of the flow guide 8 on the clean air side, there is a rapid-action coupling 15 to which an intake air line to the fuel cell 30 is connected.

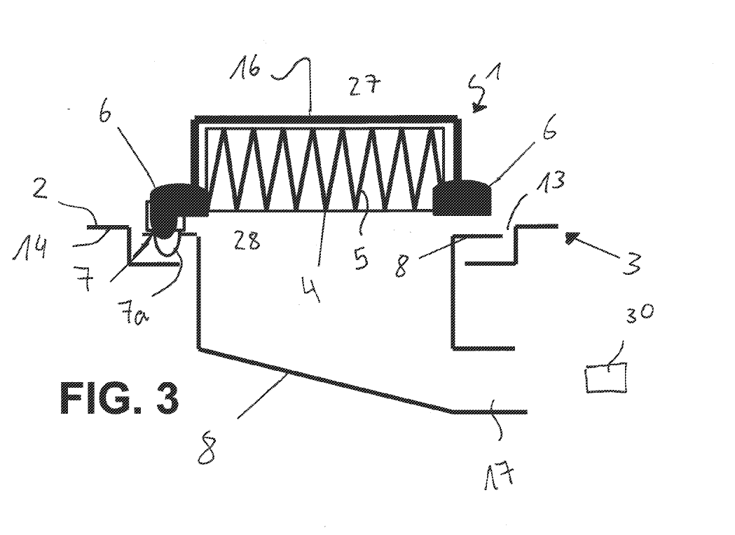

FIG. 3 shows a replaceable filter module 1 with a structure that is similar to the one shown in FIG. 1, in which the filter element 4 has a pleated filter medium 5 on which a flat filter medium 16 has been placed on the unfiltered air side.

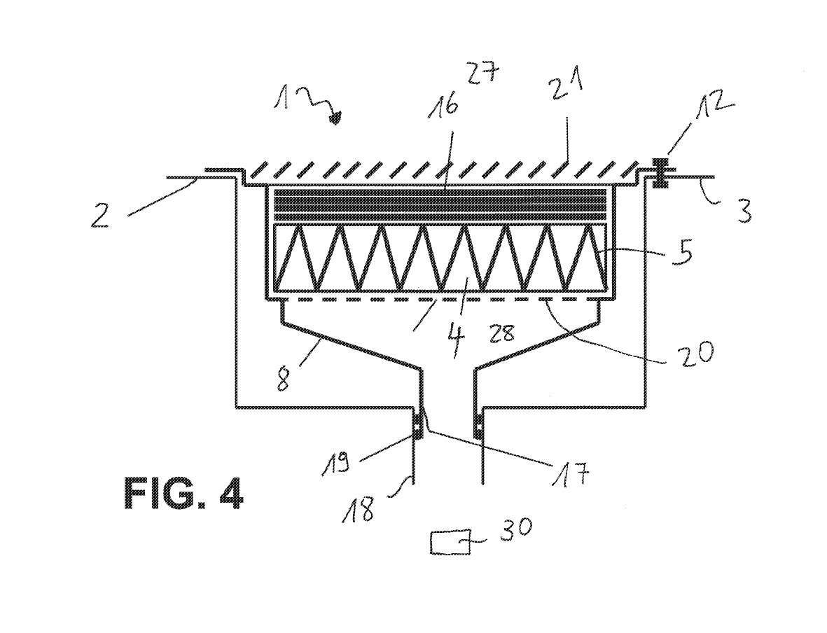

FIG. 4 shows a replaceable filter module 1 in which the filter element 4 is a pleated filter medium 5 and it has at least one flat filter medium 16. Concretely, several stacked flat filter media 16 are provided that have been placed on the pleated filter medium 5 on the unfiltered air side. The flat filter media 16 can be configured as filter foams, sintered filters, packings, filters with a honeycomb structure or with a grid structure. Fundamentally, any chemical filter or particle filter and combinations thereof can be used.

The flow guide 8 has a tapered cross section and an inlet piece 17 that can be inserted into the wall 2 and that is held in a receptacle 18 of the housing 3. Here, a means for affixing the inlet piece 17 can be provided in order to lock the replaceable filter module 1 in place.

Between the outer wall of the inlet piece 17 and the inner wall of the receptacle 18, there are sealing elements 19 that are configured as 0-rings. However, it is also possible for lip seals, axial seals and/or radial seals to be attached to the receptacle 18 or to the inlet piece 17.

On the clean air side, the filter element 4 is adjoined by a perforated plate or screen 20 in order to optimize the flow or to support flat filter media 16.

On the unfiltered air side, the filter element 4 is adjoined by a protective grid 21 as a splash guard. This grid can be configured as an integral part with the filter element 4.

The replaceable filter module 1 is locked onto the wall 2 by means of rapid-action closures 12 so that the replaceable filter module 1 can be replaced without tools.

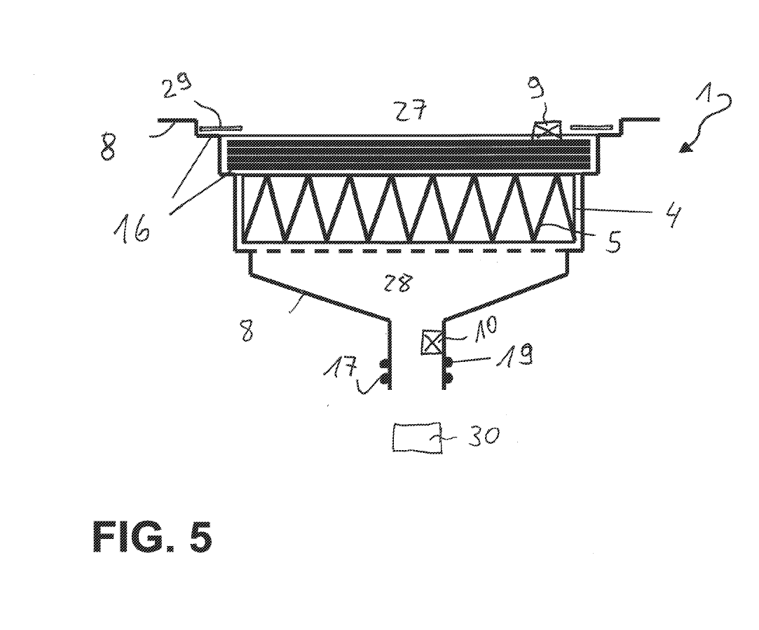

FIG. 5 shows a replaceable filter module 1 in which the filter element 4 is glued, welded or clamped onto the flow guide 8. The flat filter media 16, like the pleated filter medium 5, can be glued, welded, cast into or clamped to the flow guide 8. The filter media 5, 16 are clamped by a fixation frame 29. O-rings are arranged as sealing elements on the inlet piece 17.

FIG. 5 shows a replaceable filter module 1, whereby a first sensor 9 is associated with the filter element 4. The first sensor 9 is configured as a noxious gas dosimeter. By changing color or by emitting an electric signal, the first sensor indicates whether the filter element 4 is exhausted and has to be replaced. In the embodiment according to FIG. 5, the flow guide 8 has a second sensor 10 that is arranged on the inlet piece 17. The second sensor 10 can be used to determine the noxious gas concentration in the clean air. The second sensor 10 can also be configured as a mass flow sensor, a volume flow meter, a pressure sensor, or a particle-detecting sensor.

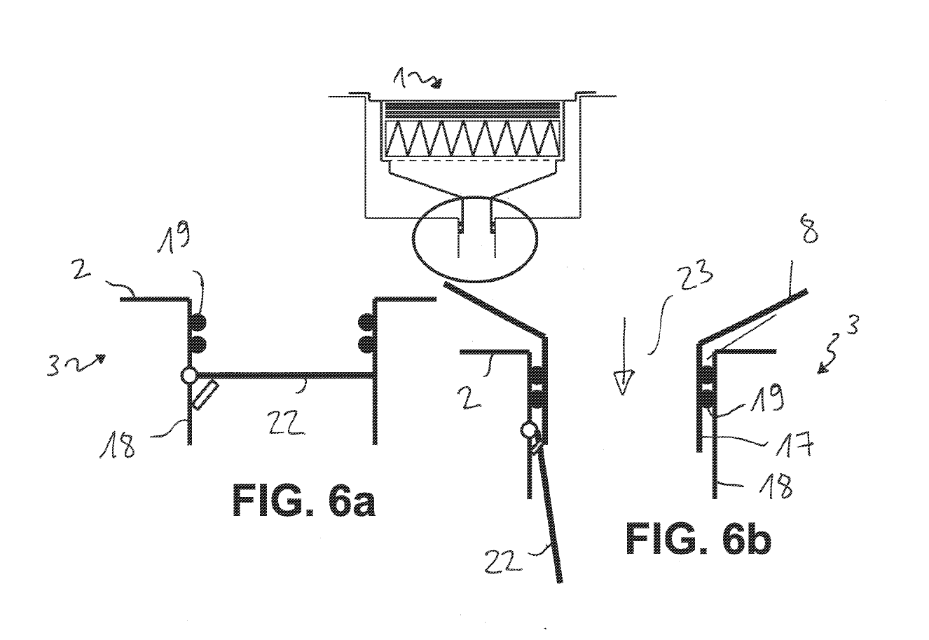

FIG. 6a shows a housing 3 with a receptacle 18 on which sealing elements 19 are arranged, which are configured as O-rings. In the receptacle 18, there is a flap 22 that closes the receptacle 18 when an inlet piece 17 is removed. This prevents contamination from getting in.

FIG. 6b shows that the inlet piece 17 moves the flap 22 downwards, thereby creating a flow channel 23. In the flow channel 23, the intake air for the fuel cell 30 flows in the direction of the arrow.

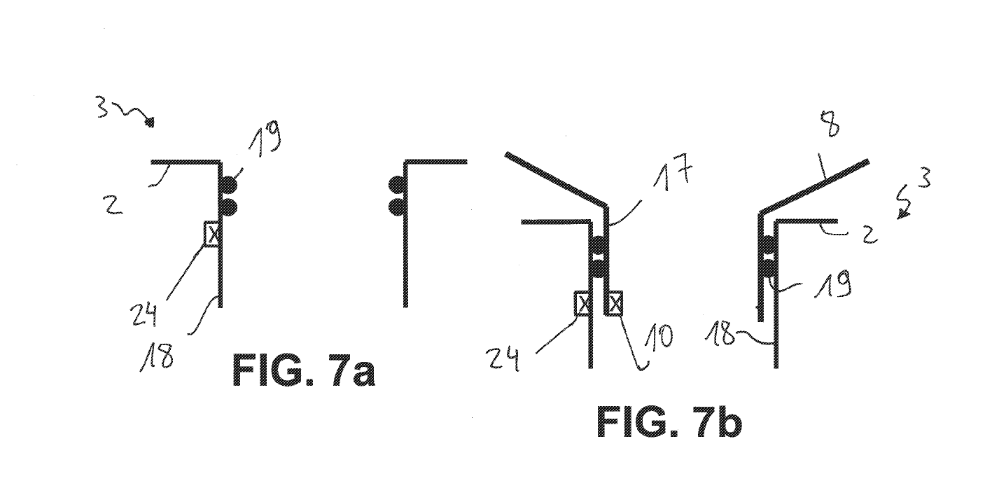

FIG. 7a shows a receptacle 18 with sealing elements 19 and a third sensor 24 is arranged on this receptacle 18. When the inlet piece 17 is inserted, the third sensor 24 corresponds to the second sensor 10 that is arranged on the inlet piece 17 or on the flow guide 8.

This is shown in FIG. 7b. The third sensor 24 detects whether an inlet piece 17 is present. Moreover, the third sensor 24, by communicating with the second sensor 10, can recognize whether a suitable replaceable filter module 1 that can operate properly has been inserted.

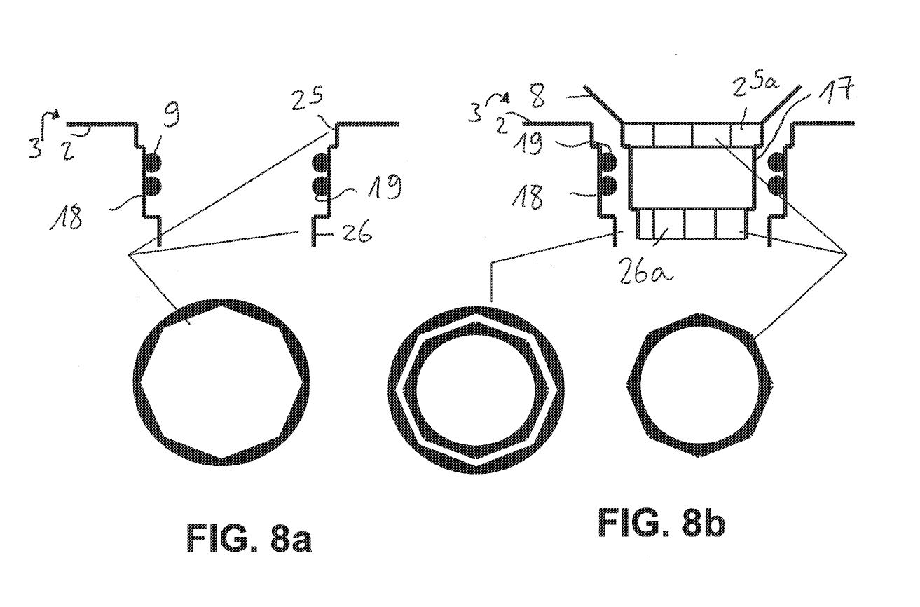

FIG. 8a shows a profiled receptacle 18. The shape of the profile is shown in a top view beneath the receptacle 18. The profile is configured in an upper section 25 as well as in a lower section 26 of the receptacle 18.

FIG. 8b shows a replaceable filter module 1 in which the inlet piece 17 is configured so as to be profiled on an upper section 25a as well as on a lower section 26a. The inlet piece 17 is inserted into the profiled receptacle 18, which is complementary to the inlet piece 17.

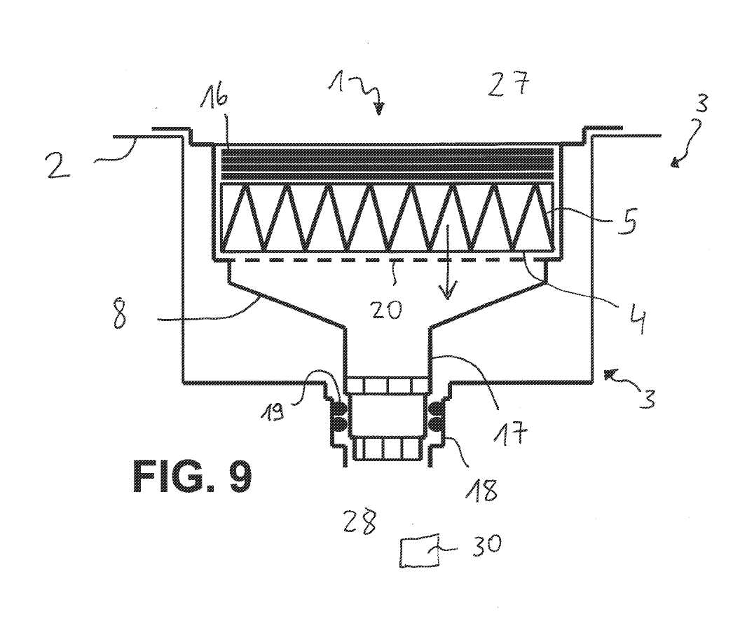

FIG. 9 shows a housing 3 with a replaceable filter module 1 in which the filter element 4 has a pleated filter medium 5 and at least one flat filter medium 16. Concretely, several stacked flat filter media 16 are provided that have been placed on the pleated filter medium 5 on the unfiltered air side. The flat filter media 16 can be configured as filter foams, sintered filters, packings, filters with a honeycomb structure or with a grid structure. Fundamentally, any chemical filter or particle filter and combinations thereof can be used.

The flow guide 8 has a profiled inlet piece 17 that is held in a profiled receptacle 18 of the housing 3 or of the wall 2. The flow guide 8 tapers in the direction of the inlet piece 17.

Between the outer wall of the inlet piece 17 and the inner wall of the receptacle 18, there are sealing elements 19 that are configured as O-rings. However, it is also possible for lip seals, axial seals and/or radial seals to be attached to the receptacle 18 or to the inlet piece 17.

On the clean air side, the filter element 4 is adjoined by a perforated plate or screen 20 for optimizing the flow or for supporting flat filter media 16. The unfiltered air side 27 is outside of the wall 2, and the clean air side 28 is downstream from the filter element 4 in the flow direction (arrow).

FIGS. 1 to 4 and 9 each depict a housing 3 that has a wall 2 and that holds a fuel cell 30 in its interior, whereby the interior is shielded off by the wall 2. The housing has a replaceable filter module 1, whereby the replaceable filter module 1 is accessible from the outside and can be detached from the wall 2.

As far as additional advantageous embodiments and refinements of the teaching according to the invention are concerned, reference is made, on the one hand, to the general part of the description and, on the other hand, to the accompanying claims.

Finally, it must be explicitly pointed out that the embodiments selected above serve merely to illustrate the teaching according to the invention, but the teaching is by no means limited to these embodiments.

While the invention has been particularly shown and described with reference to preferred embodiments thereof, it will be understood by those skilled in the art that various changes in form and details may be made therein without departing from the spirit and scope of the invention.

1-14. (canceled)

15. A replaceable filter module to be flanged to a wall of a housing that holds a fuel cell, the filter module comprising:
a filter element with a filter medium; and
at least one of a seal and sealing elements, the seal including one of a key-and-lock connection, a plug-and-socket connection, and a tongue-and-groove connection.

16. The replaceable filter recited in claim 15, further comprising a first sensor.

17. The replaceable filter recited in claim 15, wherein the filter element includes at least one of a pleated filter medium and a flat filter medium.

18. The replaceable filter recited in claim 15, wherein the filter element is connected to a flow guide by a leak-proof connection including a positive or non-positive connection.

19. The replaceable filter recited in claim 18, wherein the flow guide includes an inlet piece configured to be inserted into the wall.

20. The replaceable filter recited in claim 19, wherein the inlet piece is profiled.

21. The replaceable filter recited in claim 20, wherein the flow guide tapers in a direction of the inlet piece.

22. The replaceable filter recited in claim 18, wherein the inlet is configured to interact with a receptacle on the housing, and wherein the inlet and receptacle are configured in a key-and-lock connection or a plug-and-socket connection.

23. The replaceable filter recited in claim 18, wherein the flow guide includes a second sensor.

25. The replaceable filter recited in claim 23, wherein the filter element is connected to a flow guide by a leak-proof connection including a positive or non-positive connection.

26. The replaceable filter recited in claim 24, wherein the flow guide includes an inlet piece configured to be inserted into the wall.

27. The replaceable filter recited in claim 25, wherein the inlet piece is profiled.

28. The replaceable filter recited in claim 26, wherein the flow guide tapers in a direction of the inlet piece.

29. The replaceable filter recited in claim 24, wherein the flow guide includes a second sensor.

30. A housing comprising:
a wall;
an interior configured to hold a fuel cell, the interior being shielded by the wall; and
a replaceable filter module that is accessible from outside the housing and is detachable from the wall, the replacable filter module including:
a filter element with a filter medium, and
at least one of a seal and sealing elements, the seal including one of a key-and-lock connection, a plug-and-socket connection, and a tongue-and-groove connection.

31. The housing recited in claim 30, wherein the replaceable filter module is connected to the wall by a fixation device.

32. The housing recited in claim 31, wherein the fixation device includes a tenter frame.

33. The housing recited in claim 30, wherein the filter module includes first and second sensors and wherein a third sensor is disposed on the housing.
